(19) United States
(12) Patent Application Publication
(10) Pub. No.: US 2015/0351149 A1
(43) Pub. Date: Dec. 3, 2015

(54) SYSTEMS AND METHODS FOR ENHANCED CALL RE-ESTABLISHMENT

(71) Applicant: QUALCOMM Incorporated, San Diego, CA (US)

(72) Inventors: Venkata Raji Reddy Kanthala, Hyderabad (IN); Surendra Kompala, Hyderabad (IN)

(73) Assignee: QUALCOMM Incorporated, San Diego, CA (US)

(21) Appl. No.: 14/295,066

(22) Filed: Jun. 3, 2014

(51) Int. Cl. H04W 76/02; H04W 36/16

(52) U.S. Cl. CPC H04W 76/028; H04W 36/16

(57) ABSTRACT

A method for call re-establishment by a wireless communication device is described. The method includes obtaining system information from one or more neighbor cells in a wireless communication system. The method also includes determining whether the one or more neighbor cells support call re-establishment based on the system information. The method further includes attempting call re-establishment only on neighbor cells that support call re-establishment.

### TECHNICAL FIELD

The present disclosure relates generally to communication systems. More specifically, the present disclosure relates to systems and methods for enhanced call re-establishment.

### BACKGROUND

Wireless communication systems have become an important means by which many people worldwide have come to communicate. A wireless communication system may provide communication for a number of wireless communication devices, each of which may be serviced by one or more base stations.

Sometimes a wireless communication device will lose a call due to loss of radio coverage or unacceptable interference. The wireless communication device may then perform call re-establishment. Benefits may be realized by reducing the amount of time that a wireless communication device takes to perform call re-establishment.

### SUMMARY

A method for call re-establishment by a wireless communication device is described. The method includes obtaining system information from one or more neighbor cells in a wireless communication system. The method also includes determining whether the one or more neighbor cells support call re-establishment based on the system information. The method further includes attempting call re-establishment only on neighbor cells that support call re-establishment.

Attempting call re-establishment may occur when a radio link failure is detected. The wireless communication system may be a Global System for Mobile Communications (GSM) system.

Attempting call re-establishment only on neighbor cells that support call re-establishment may include skipping neighbor cells that do not support call re-establishment.

The method may also include maintaining a call re-establishment supported list of neighbor cells that support call re-establishment. The method may further include identifying neighbor cells that support call re-establishment using information from the system information. The method may additionally include adding the neighbor cells that support call re-establishment to the call re-establishment supported list. The method may also include attempting call re-establishment on neighbor cells based on the call re-establishment supported list.

The method may also include obtaining, from a neighbor cell, the system information from a radio resource (RR) message when in idle mode or by decoding neighbor cell system information using a tuneaway mechanism when in dedicated mode. The system information may be at least one of a system information type 3 (SI3) message or a system information type 4 (SI4) message or other system information containing a random access channel (RACH) control parameter information element (IE).

The method may also include receiving, while camped on a serving cell, a neighbor cell list that includes the one or more neighbor cells. The method may further include maintaining a strongest received signals list of neighbor cells with strongest average received signal levels that are considered for call re-establishment. The method may additionally include maintaining a call re-establishment supported list of neighbor cells that support call re-establishment. The method may also include maintaining a call re-establishment candidate list that is an intersection of the strongest received signals list and the call re-establishment supported list. Attempting call re-establishment only on neighbor cells that support call re-establishment may include attempting call re-establishment only on neighbor cells in the call re-establishment candidate list.

An apparatus for call re-establishment is also described. The apparatus includes a processor, memory in electronic communication with the processor and instructions stored in the memory. The apparatus obtains system information from one or more neighbor cells in a wireless communication system. The apparatus determines whether the one or more neighbor cells support call re-establishment based on the system information. The apparatus attempts call re-establishment only on neighbor cells that support call re-establishment.

A wireless communication device for call re-establishment is also described. The wireless communication device includes means for obtaining system information from one or more neighbor cells in a wireless communication system. The wireless communication device also includes means for determining whether the one or more neighbor cells support call re-establishment based on the system information. The wireless communication device further includes means for attempting call re-establishment only on neighbor cells that support call re-establishment.

A computer-program product for call re-establishment is also described. The computer-program product includes a non-transitory computer-readable medium having instructions thereon. The instructions include code for causing a wireless communication device to obtain system information from one or more neighbor cells in a wireless communication system. The instructions also include code for causing the wireless communication device to determine whether the one or more neighbor cells support call re-establishment based on the system information. The instructions further include code for causing the wireless communication device to attempt call re-establishment only on neighbor cells that support call re-establishment.

### BRIEF DESCRIPTION OF THE DRAWINGS

FIG. 1 is a block diagram illustrating a wireless communication system with a wireless communication device, a serving cell and one or more neighbor cells for performing enhanced call re-establishment;

FIG. 2 is a flow diagram of a method for performing enhanced call re-establishment;

FIG. 3 is a block diagram illustrating a wireless communication system operating in accordance with the described systems and methods;

FIG. 4 is a flow diagram illustrating a detailed configuration of a method for performing enhanced call re-establishment;

FIG. 5 is a block diagram illustrating a configuration of a wireless communication system for performing enhanced call re-establishment;

FIG. 6 is a flow diagram illustrating another detailed configuration of a method for performing enhanced call re-establishment;

FIG. 7 illustrates certain components that may be included within a wireless communication device; and

FIG. 8 illustrates certain components that may be included within a base station.

### DETAILED DESCRIPTION

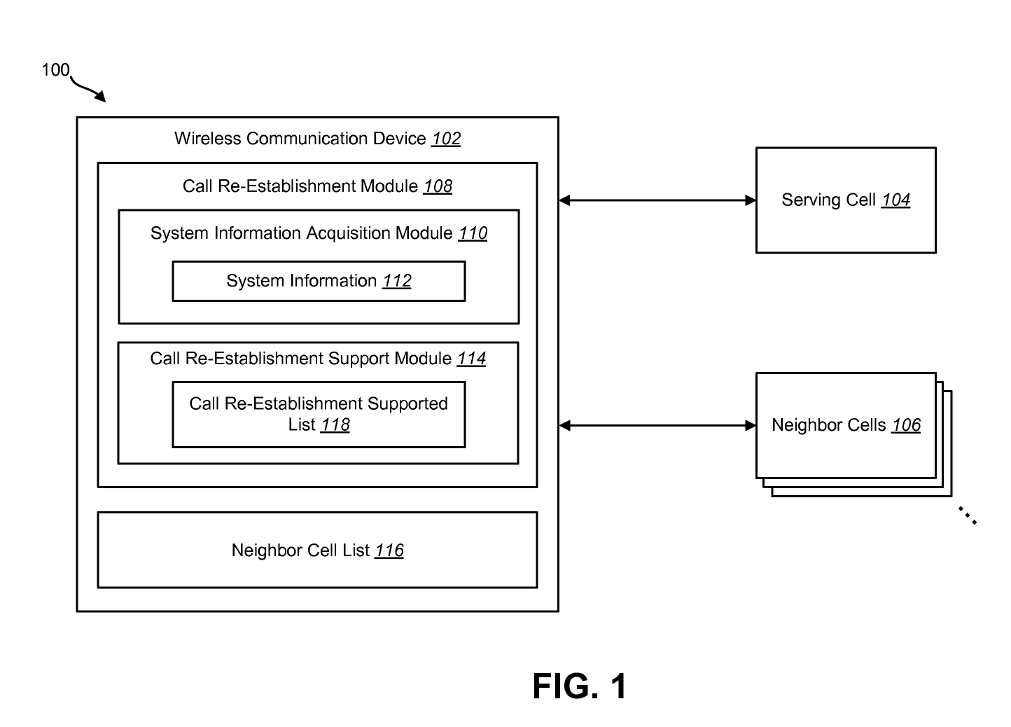

FIG. 1 is a block diagram illustrating a wireless communication system 100 with a wireless communication device 102, a serving cell 104 and one or more neighbor cells 106 for performing enhanced call re-establishment. Wireless communication systems 100 are widely deployed to provide various types of communication content such as voice, data and so on. Enhanced call re-establishment may be performed on the wireless communication system 100 according to the systems and methods described herein.

The serving cell 104 and the one or more neighbor cells 106 may be provided by a base station. The term “cell” can refer to a base station and/or the coverage area of a base station depending on the context in which the term is used. A base station is a station that may communicate with one or more wireless communication devices 102. A base station may also be referred to as, and may include some or all of the functionality of an access point, a broadcast transmitter, a NodeB, an evolved NodeB, a base transceiver station, etc. The term “base station” will be used herein. Each base station may provide communication coverage for a particular geographic area. A base station may provide communication coverage for one or more wireless communication devices 102.

A base station may provide one or more cells. For example, a first base station may provide a serving cell 104 and a second base station may provide a neighbor cell 106. In another configuration, a single base station may provide both a serving cell 104 and one or more neighbor cells 106.

Communications in a wireless system (e.g., a multiple-access system) may be achieved through transmissions over a wireless link. Such a wireless link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

The wireless communication system 100 may also be referred to as a “network” or “wireless network.” The wireless communication system 100 may utilize MIMO. A MIMO system may support both time division duplex (TDD) and frequency division duplex (FDD) systems. In a TDD system, uplink and downlink transmissions are on the same frequency region so that the reciprocity principle allows the estimation of the downlink channel from the uplink channel. This enables a transmitting wireless device (e.g., wireless communication device 102 or base station) to extract transmit beamforming gain from communications received by the transmitting wireless device.

The wireless communication system 100 may be a multiple-access system capable of supporting communication with multiple wireless communication devices 102 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO), single-carrier frequency division multiple access (SC-FDMA) systems, 3^{rd} Generation Partnership Project (3GPP) Long Term Evolution (LTE) systems, and spatial division multiple access (SDMA) systems.

The terms “networks” and “systems” are often used interchangeably. A CDMA network may implement a radio technology such as Universal Terrestrial Radio Access (UTRA), cdma2000, etc. UTRA includes W-CDMA and Low Chip Rate (LCR) while cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

The 3^{rd} Generation Partnership Project (3GPP) is a collaboration between groups of telecommunications associations that aims to define a globally applicable 3^{rd} generation (3G) mobile phone specification. 3GPP Long Term Evolution (LTE) is a 3GPP project aimed at improving the Universal Mobile Telecommunications System (UMTS) mobile phone standard. The 3GPP may define specifications for the next generation of mobile networks, mobile systems and mobile devices.

In 3GPP Long Term Evolution (LTE) and UMTS, a wireless communication device 102 may be referred to as a “user equipment” (UE). In 3GPP Global System for Mobile Communications (GSM), a wireless communication device 102 may be referred to as a “mobile station” (MS). A wireless communication device 102 may also be referred to as, and may include some or all of the functionality of, a terminal, an access terminal, a subscriber unit, a station, etc. A wireless communication device 102 may be a cellular phone, a personal digital assistant (PDA), a wireless device, a wireless modem, a handheld device, a laptop computer, a Session Initiation Protocol (SIP) phone, a wireless local loop (WLL) station, an appliance (e.g., dishwasher, refrigerator, laundry machine, etc.), a sensor, a wearable computing device (e.g., a smartwatch, a health or fitness tracker, etc.), a vending machine, etc.

A wireless communication device 102 may communicate with zero, one or multiple base stations on the downlink and/or uplink at any given moment. The downlink (or forward link) refers to the communication link from a base station to a wireless communication device 102, and the uplink (or reverse link) refers to the communication link from a wireless communication device 102 to a base station.

The wireless communication device 102 may be camped on the serving cell 104. The term “camp” refers to a process in which the wireless communication device 102 monitors a cell for system information 112 and paging information. The wireless communication device 102 may receive paging information on a paging channel. The cell on which the wireless communication device 102 is camped is referred to as the serving cell 104.

According to one approach, in the event of a radio link failure while camped on a serving cell 104, call re-establishment may be attempted on a neighbor cell 106. Radio link failure may occur due to poor radio conditions. For example, when the wireless communication device 102 may not be able to decode one or more slow associated control channel (SACCH) messages, the wireless communication device 102 may declare a radio link failure. The declaration of a radio link failure may result in either re-establishment or release of a call that is in progress.

The criteria for determining radio link failure in the wireless communication device 102 may be based on the success rate of decoding messages on the downlink slow associated control channel (SACCH). The aim of determining radio link failure in the wireless communication device 102 is to ensure that calls with unacceptable voice or data quality, which cannot be improved either by radio frequency (RF) power control or handover, are either re-established or released in a defined manner.

Upon detection of a radio link failure, the wireless communication device 102 may perform various steps to select a neighbor cell 106 on which to attempt call re-establishment. The wireless communication device 102 may measure the received average signal level (e.g., Rxlevel) of the neighbor cells 106 in a neighbor cell list 116. According to one approach, the wireless communication device 102 may average the received signal level measurement samples taken in the last 5 seconds on the neighbor cells 106 indicated in the neighbor cell list 116 and on the serving cell 104 broadcast control channel (BCCH) carrier. The neighbor cell list 116 may be received on the serving cell 104. In one configuration, the neighbor cell list 116 may be a BCCH allocation (BA) list that is broadcast on a SACCH of the serving cell 104.

According to one approach, the neighbor cell 106 with the highest average received signal level with a permitted network color code (NCC) as indicated on the SACCH of the serving cell 104 may be selected for a call re-establishment attempt. On this neighbor cell 106, the wireless communication device 102 may attempt to decode the BCCH data block containing the parameters affecting cell selection. If the neighbor cell 106 is suitable and call re-establishment is supported (e.g., allowed) on the neighbor cell 106, then call re-establishment may be attempted on this neighbor cell 106. If the wireless communication device 102 is unable to decode the BCCH data block of the neighbor cell 106 or if the neighbor cell 106 is unsuitable or does not support call re-establishment, then the neighbor cell 106 with the next highest average received signal level with a permitted NCC may be selected for a call re-establishment attempt.

In one implementation, the wireless communication device 102 may attempt call re-establishment on N neighbor cells 106 with the strongest average received signal level values, where N is a configurable number. In one implementation, N may be 6. If call re-establishment on the N neighbor cells 106 with the strongest average received signal level values has not been successful, the call re-establishment attempt may be abandoned. The wireless communication device 102 may then perform procedures to release the channels on the serving cell 104, enter idle mode and perform cell reselection.

According to this approach, if some of the strongest average received signal level neighbor cells 106 do not support call re-establishment, then there is a chance that a user may notice a degradation in the voice quality because of the radio link failure and the subsequent amount of time taken for identifying a neighbor cell 106 for the call re-establishment.

The wireless communication device 102 may perform a power scan for the neighbor cells 106 included in the neighbor cell list 116. The power scan may take x seconds. In some implementations, the power scan may take 2 seconds. The wireless communication device 102 may then attempt call re-establishment in the strongest N neighbor cells 106. For each acquisition of a neighbor cell 106, the wireless communication device 102 may acquire the frequency correction channel (FCCH), decode the synchronization channel (SCH) and decode the BCCH before determining whether the neighbor cell 106 supports call re-establishment. This acquisition process may take y seconds per neighbor cell 106. In some typical implementations, the acquisition process may take up to two seconds per neighbor cell 106.

In some configurations, the wireless communication device 102 may not access a neighbor cell 106 to attempt call re-establishment later than 20 seconds after the detection within the wireless communication device 102 of the radio link failure causing the call re-establishment attempt. In the case where the 20 seconds elapses without a successful call re-establishment, the call re-establishment attempt may be abandoned, and the wireless communication device 102 may then perform procedures to release the channels on the serving cell 104, enter idle mode and perform cell reselection.

In a worst-case scenario for call re-establishment, only the last neighbor cell 106 of the N neighbor cells 106 with the strongest average signal levels supports call re-establishment. In this worst-case scenario, the wireless communication device 102 must first acquire the first N−1 neighbor cells 106 with the strongest average signal levels before attempting call re-establishment on the last neighbor cell 106. Therefore, the wireless communication device 102 may waste (N−1)×y seconds before attempting call re-establishment on the last neighbor cell 106. In one implementation, N is 6 (corresponding to the 6 neighbor cells 106 with strongest average signal levels) and y is 2 seconds. Therefore, the wireless communication device 102 may waste (6−1)×2=10 seconds before attempting call re-establishment on the last neighbor cell 106.

In one example scenario, the wireless communication device 102 may be camped on a serving cell 104 denoted as Cell A. The wireless communication device 102 may receive a neighbor cell list 116 (on the SACCH, for example) that includes the following neighbor cells 106: Cell B, Cell C, Cell D, Cell E, Cell F and Cell G.

As described above, the wireless communication device 102 may measure the received average signal level (e.g., Rxlevel) of the neighbor cells 106 in the neighbor cell list 116. In this scenario, the order of the measured average signal level from strongest to weakest is Cell B>Cell C>Cell D>Cell E>Cell F>Cell G. Furthermore, the status of whether the neighbor cells 106 support call re-establishment is Cell B (RE=1), Cell C (RE=1), Cell D (RE=1), Cell E (RE=1), Cell F (RE=0) and Cell G (RE=0), where RE=1 indicates that the neighbor cell 106 does not support (or allow) call re-establishment and RE=0 indicates that the neighbor cell 106 does support call re-establishment. Therefore, in this scenario, only Cell F and Cell G support call re-establishment.

According to this approach, the wireless communication device 102 must first acquire the neighbor cells 106 with the strongest average signal levels. Upon acquiring a neighbor cell 106, the wireless communication device 102 may determine whether the neighbor cell 106 supports call re-establishment. In this scenario, the wireless communication device 102 may attempt call re-establishment in the order Cell B, Cell C, Cell D, Cell E, Cell F and Cell G. Therefore, the wireless communication device 102 must first acquire Cell B, Cell C, Cell D and Cell E (that do not support call re-establishment) before acquiring and attempting call re-establishment on Cell F and Cell G that support call re-establishment. In this scenario, call re-establishment gets delayed and a user may notice audio quality degradation.

To improve call re-establishment, a call re-establishment module 108 may perform enhanced call re-establishment. In one configuration, the call re-establishment module 108 may include one or more of a system information acquisition module 110 and a call re-establishment support module 114. The system information acquisition module 110 may obtain system information 112 from the one or more neighbor cells 106 in a wireless communication system 100.

In one configuration, the system information 112 may be a system information type 3 (SI3) message, a system information type 4 (SI4) message or any other system information containing a random access channel (RACH) control parameter information element (IE).

While in idle mode, the wireless communication device 102 may acquire the system information 112 of the neighbor cells 106 included in the neighbor cell list 116 from a radio resource (RR) message. For example, the wireless communication device 102 may receive an RR message from one or more of the neighbor cells 106 included in the neighbor cell list 116.

While in a dedicated mode, the wireless communication device 102 may acquire the system information 112 of the neighbor cells 106 included in the neighbor cell list 116 using a tuneaway mechanism. As used herein, dedicated mode includes the mode of operation when the wireless communication device 102 is making a call. The call may be a voice call and/or a data call.

To acquire the system information 112 using a tuneaway mechanism during dedicated mode, the wireless communication device 102 may drop one or more traffic channel (TCH) blocks. In multi-SIM (e.g., Dual SIM Dual Standby (DSDS)) solutions, when one subscription (e.g., transfer subscription) is in an active data state, the other subscription (e.g., idle subscription) will not be able to decode the paging channel (PCH) because the radio resources are used for active data transmission and reception on the transfer subscription. Using a tuneaway mechanism, the active data on the transfer subscription may be suspended for the duration of the paging on the idle subscription and the radio resources may be used to decode the paging channel of the idle subscription so that idle subscriptions will not miss the mobile terminated calls. Therefore, the tuneaway mechanism may be used to decode the system information (received on a BCCH channel, for example) of the neighbor cells 106 by suspending/dropping one or more traffic channel (TCH) blocks of the same subscription.

The call re-establishment support module 114 may determine whether the one or more neighbor cells 106 support call re-establishment based on the system information 112. In one configuration, the call re-establishment support module 114 may maintain a call re-establishment supported list 118. The call re-establishment supported list 118 may include neighbor cells 106 that support call re-establishment. The call re-establishment support module 114 may use information from the system information 112 to identify neighbor cells 106 that support call re-establishment. If the system information 112 indicates that a neighbor cell 106 supports call re-establishment, then the call re-establishment support module 114 may add that neighbor cell 106 to the call re-establishment supported list 118.

In one configuration, the information from the system information 112 that may be used to identify neighbor cells 106 that support call re-establishment may include a RACH control parameter IE. The RACH control parameter IE may be received in one or more of the following system information: system information type 1, system information type 2, system information type 2bis, system information type 3, system information type 4, system information type 9. The RACH control parameter IE of a particular neighbor cell 106 may contain an RE bit that indicates whether re-establishments are allowed or not. For example, when the RE bit=1, call re-establishment is allowed in the neighbor cell 106, but when the RE bit=0, call re-establishment is not allowed in the neighbor cell 106.

While in idle mode and/or dedicated mode, the call re-establishment support module 114 may add a neighbor cell 106 to the call re-establishment supported list 118 if the system information 112 indicates that the neighbor cell 106 supports call re-establishment. Furthermore, the call re-establishment support module 114 may omit a neighbor cell 106 from the call re-establishment supported list 118 if the system information 112 indicates that the neighbor cell 106 does not support call re-establishment. Additionally, the call re-establishment support module 114 may remove a neighbor cell 106 from the call re-establishment supported list 118 if the neighbor cell 106 is included in the list, but the system information 112 indicates that the neighbor cell 106 does not support call re-establishment.

The call re-establishment module 108 may attempt call re-establishment only on neighbor cells 106 that support call re-establishment. The call re-establishment module 108 may attempt call re-establishment upon detecting a radio link failure. In one configuration, the call re-establishment module 108 may skip neighbor cells 106 that do not support call re-establishment. In one configuration, the call re-establishment module 108 may determine whether to attempt call re-establishment based on the call re-establishment supported list 118.

It should be noted that the wireless communication device 102 determines whether to attempt call re-establishment on a neighbor cell 106 based on the system information 112 of the neighbor cell 106, not on past performance of the neighbor cell 106. Furthermore, the described systems and methods do not require modifications to the base stations of the wireless communication system 100. In other words, the described systems and methods may be implemented on the wireless communication device 102.

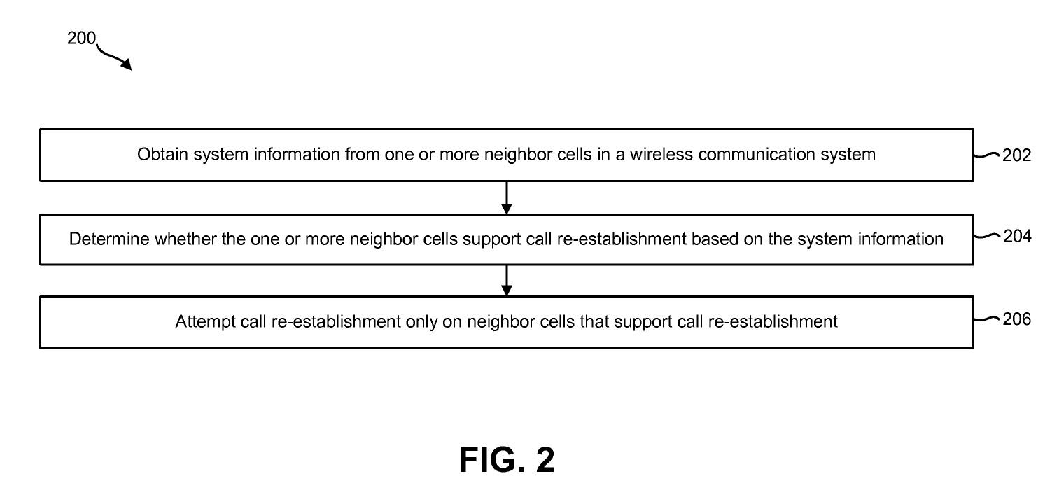

FIG. 2 is a flow diagram of a method 200 for performing enhanced call re-establishment. The method 200 may be performed by a wireless communication device 102. The wireless communication device 102 may be camped on a serving cell 104. While camped on the serving cell 104, the wireless communication device 102 may receive a neighbor cell list 116 that includes one or more neighbor cells 106. In one configuration, the neighbor cell list 116 may be a BA list that is broadcast on a SACCH of the serving cell 104. The one or more neighbor cells 106 may be of the same radio access technology (RAT) as the serving cell 104. In one implementation, the wireless communication system 100 may be a GSM system.

The wireless communication device 102 may obtain 202 system information 112 from the one or more neighbor cells 106 in the wireless communication system 100. In one configuration, the system information 112 may be a system information type 3 (SI3) message, a system information type 4 (SI4) message or any other system information containing a RACH control parameter IE. While in idle mode, the wireless communication device 102 may acquire the system information 112 of the neighbor cells 106 included in a neighbor cell list 116 from a radio resource (RR) message. In one implementation, the wireless communication device 102 may receive an RR message from each of the one or more of the neighbor cells 106 included in the neighbor cell list 116. In another implementation, the wireless communication device 102 may receive a single RR message for all neighbor cells 106 included in the neighbor cell list 116.

While in dedicated mode (e.g., during a voice call or data call), the wireless communication device 102 may acquire the system information 112 of the neighbor cells 106 included in the neighbor cell list 116 using a tuneaway mechanism. To acquire the system information 112 using the tuneaway mechanism during dedicated mode, the wireless communication device 102 may drop one or more traffic channel (TCH) blocks.

The wireless communication device 102 may determine 204 whether the one or more neighbor cells 106 support call re-establishment based on the system information 112. In one configuration, the wireless communication device 102 may maintain a call re-establishment supported list 118. The call re-establishment supported list 118 may be a list of neighbor cells 106 that support call re-establishment. The wireless communication device 102 may use information from the system information 112 to identify the neighbor cells 106 that support call re-establishment.

While in idle mode and/or dedicated mode, the wireless communication device 102 may add a neighbor cell 106 to the call re-establishment supported list 118 if the system information 112 indicates that the neighbor cell 106 supports call re-establishment. Furthermore, the wireless communication device 102 may omit a neighbor cell 106 from the call re-establishment supported list 118 if the system information 112 indicates that the neighbor cell 106 does not support call re-establishment. Additionally, the wireless communication device 102 may remove a neighbor cell 106 from the call re-establishment supported list 118 if the neighbor cell 106 is included in the call re-establishment supported list 118, but the system information 112 indicates that the neighbor cell 106 does not support call re-establishment.

The wireless communication device 102 may attempt 206 call re-establishment only on neighbor cells 106 that support call re-establishment. The wireless communication device 102 may skip neighbor cells 106 that do not support call re-establishment.

The wireless communication device 102 may attempt 206 call re-establishment upon detecting a radio link failure. In one implementation, the wireless communication device 102 may declare a radio link failure upon expiration of a radio link counter. For example, the radio link counter may be set to a RADIO_LINK_TIMEOUT counter (e.g., RADIO_LINK_TIMEOUT=64). If the wireless communication device 102 is unable to decode a SACCH message, then the radio link counter may be decreased by 1. If the radio link counter reaches 0, then the wireless communication device 102 may declare a radio link failure.

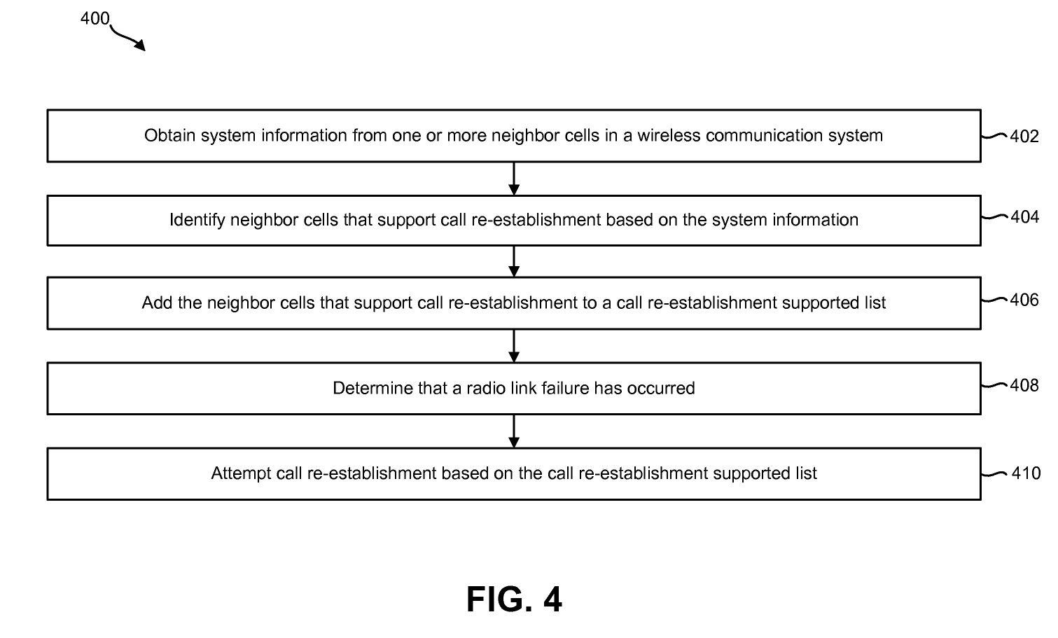

In one configuration, the wireless communication device 102 may determine whether to attempt 206 call re-establishment on a neighbor cell 106 based on the call re-establishment supported list 118. This may be accomplished as described below in connection with FIG. 4.

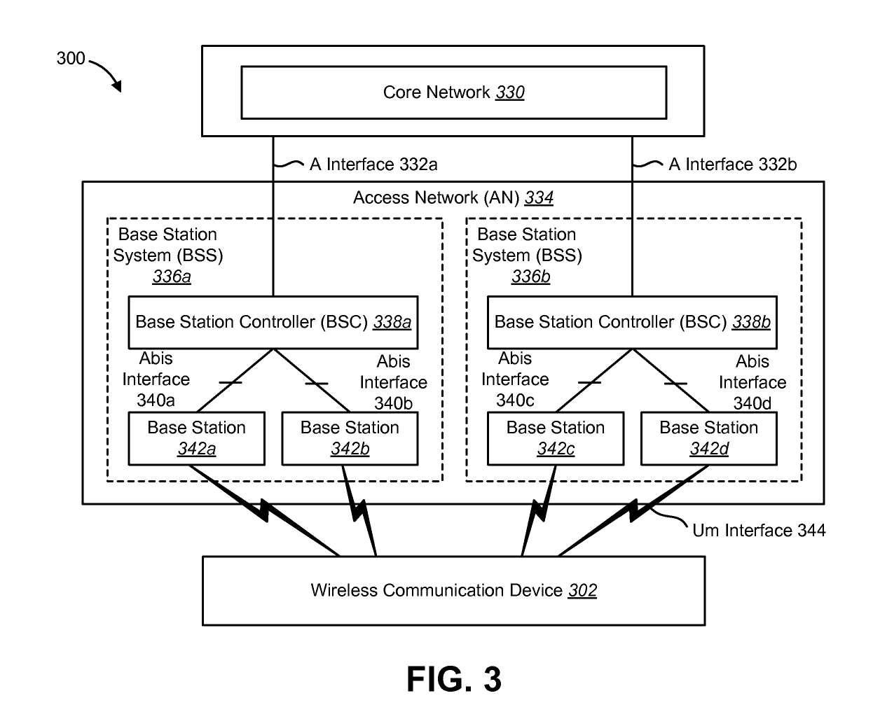

FIG. 3 is a block diagram illustrating a wireless communication system 300 operating in accordance with the described systems and methods. The wireless communication system 300 may operate according to Global System for Mobile Communications (GSM) standards and may be referred to as a GSM system or a GSM network. A GSM system is a collective term for the base stations 342a-d and the control equipment for the base stations 342a-d (e.g., base station controllers (BSCs) 338a-b) the GSM system may contain, which make up the access network (AN) 334. The GSM system provides an air interface access method for the wireless communication device 302. Connectivity is provided between the wireless communication device 302 and the core network 330 by the GSM system. The access network (AN) 334 may transport data packets between multiple wireless communication devices 302.

The GSM system is connected internally or externally to other functional entities by various interfaces (e.g., an A interface 332a-b, an Abis interface 340a-d, and a Um interface 344). The GSM system is attached to a core network 330 via an external interface (e.g., an A interface 332a-b). The base station controllers (BSCs) 338a-b support this interface. In addition, the base station controllers (BSCs) 338a-b manage a set of base stations 342a-d through Abis interfaces 340a-d. A base station controller (BSC) 338a and the managed base stations 342a-b form a base station system (BSS) 336a. A base station controller (BSC) 338b and the managed base stations 342c-d form a base station system (BSS) 336b. The Um interface 344 connects a base station 342 with a wireless communication device 302, while the Abis interface 340 is an internal interface connecting the base station controller (BSC) 338 with the base station 342.

The wireless communication system 300 may be further connected to additional networks outside the wireless communication system 300, such as a corporate intranet, the Internet, or a conventional public switched telephone network. The wireless communication system 300 may transport data packets between each wireless communication device 302 and such outside networks.

GSM is a widespread standard in cellular, wireless communication. GSM is relatively efficient for standard voice services. However, high-fidelity audio and data services may require higher data throughput rates than that for which GSM is optimized. To increase capacity, the General Packet Radio Service (GPRS), EDGE (Enhanced Data rates for GSM Evolution) and UMTS (Universal Mobile Telecommunications System) standards have been adopted in GSM systems. In the GSM/EDGE Radio Access Network (GERAN) specification, GPRS and EGPRS provide data services. The standards for GERAN are maintained by the 3GPP (Third Generation Partnership Project). GERAN is a part of GSM. More specifically, GERAN is the radio part of GSM/EDGE together with the network that joins the base stations 342 (the Ater and Abis interfaces 340) and the base station controllers (A interfaces 332, etc.). GERAN represents the core of a GSM system. It routes phone calls and packet data from and to the PSTN (Public Switched Telephone Network) and Internet to and from remote terminals. GERAN is also a part of combined UMTS/GSM networks.

GSM employs a combination of Time Division Multiple Access (TDMA) and Frequency Division Multiple Access (FDMA) for the purpose of sharing the spectrum resource. GSM systems typically operate in a number of frequency bands. For example, for uplink communication, GSM-900 commonly uses a radio spectrum in the 890-915 megahertz (MHz) bands (Mobile Station to Base Transceiver Station). For downlink communication, GSM-900 uses 935-960 MHz bands (base station 342 to wireless communication device 302). Furthermore, each frequency band is divided into 200 kHz carrier frequencies providing 124 RF channels spaced at 200 kHz. GSM-1900 uses the 1850-1910 MHz bands for the uplink and 1930-1990 MHz bands for the downlink Like GSM-900, FDMA divides the spectrum for both uplink and downlink into 200 kHz-wide carrier frequencies. Similarly, GSM-850 uses the 824-849 MHz bands for the uplink and 869-894 MHz bands for the downlink, while GSM-1800 uses the 1710-1785 MHz bands for the uplink and 1805-1880 MHz bands for the downlink.

Each channel in GSM is identified by a specific absolute radio frequency channel (ARFCN). For example, ARFCN 1-124 are assigned to the channels of GSM-900, while ARFCN 512-810 are assigned to the channels of GSM-1900. Similarly, ARFCN 128-251 are assigned to the channels of GSM-850, while ARFCN 512-885 are assigned to the channels of GSM-1800. Also, each base station 342 is assigned one or more carrier frequencies. Each carrier frequency is divided into eight time slots (which are labeled as time slots 0 through 7) using TDMA such that eight consecutive time slots form one TDMA frame with a duration of 4.615 milliseconds (ms). A physical channel occupies one time slot within a TDMA frame. Each active wireless communication device 302 or user is assigned one or more time slot indices for the duration of a call. User-specific data for each wireless communication device 302 is sent in the time slot(s) assigned to that wireless communication device 302 and in TDMA frames used for the traffic channels.

FIG. 4 is a flow diagram illustrating a detailed configuration of a method 400 for performing enhanced call re-establishment. The method 400 may be performed by a wireless communication device 102. The wireless communication device 102 may be camped on a serving cell 104. While camped on the serving cell 104, the wireless communication device 102 may receive a neighbor cell list 116 that includes one or more neighbor cells 106. This may be accomplished as described above in connection with FIG. 2. In one implementation, the wireless communication system 100 may be a GSM system.

The wireless communication device 102 may obtain 402 system information 112 from the one or more neighbor cells 106 in the wireless communication system 100. This may be accomplished as described above in connection with FIG. 2. In one configuration, the system information 112 may be a system information type 3 (SI3) message, a system information type 4 (SI4) message or any other system information containing a RACH control parameter IE. While in idle mode, the wireless communication device 102 may obtain 402 the system information 112 from one or more radio resource (RR) messages received from the neighbor cells 106. While in dedicated mode, the wireless communication device 102 may obtain 402 the system information 112 of the neighbor cells 106 using the tuneaway mechanism.

The wireless communication device 102 may identify 404 neighbor cells 106 that support call re-establishment based on the system information 112. The system information 112 may include information that indicates whether a neighbor cell 106 supports call re-establishment.

The wireless communication device 102 may add 406 neighbor cells 106 that support call re-establishment to a call re-establishment supported list 118. In one configuration, the call re-establishment supported list 118 may be a database that is stored on the wireless communication device 102.

The call re-establishment supported list 118 may include a cell identifier (ID) that may identify a particular neighbor cell 106. In one implementation, the cell ID may be an ARFCN associated with a neighbor cell 106. Therefore, the wireless communication device 102 may add one or more ARFCNs associated with the neighbor cells 106 that support call re-establishment to the call re-establishment supported list 118.

The neighbor cells 106 that are included in the call re-establishment supported list 118 may be selected from the neighbor cell list 116. As the wireless communication device 102 changes location, or neighbor cells 106 are added or removed from the wireless communication system 100, the neighbor cell list 116 may change. Therefore, the wireless communication device 102 may add 406 to the call re-establishment supported list 118 only those neighbor cells 106 that are included in the current neighbor cell list 116 and support call re-establishment.

In one implementation, the wireless communication device 102 may create a new call re-establishment supported list 118 each time the serving cell 104 provides a new neighbor cell list 116. In another implementation, the wireless communication device 102 may update the call re-establishment supported list 118 (e.g., add or remove neighbor cells 106) based on the current neighbor cell list 116.

The wireless communication device 102 may determine 408 that a radio link failure has occurred. This may be accomplished as described above in connection with FIG. 2. For example, when a radio link counter reaches 0, the wireless communication device 102 may declare a radio link failure.

The wireless communication device 102 may attempt 410 call re-establishment based on the call re-establishment supported list 118. For example, the wireless communication device 102 may attempt 410 call re-establishment only on neighbor cells 106 that are included in call re-establishment supported list 118. In one configuration, the wireless communication device 102 may skip neighbor cells 106 that do not support call re-establishment.

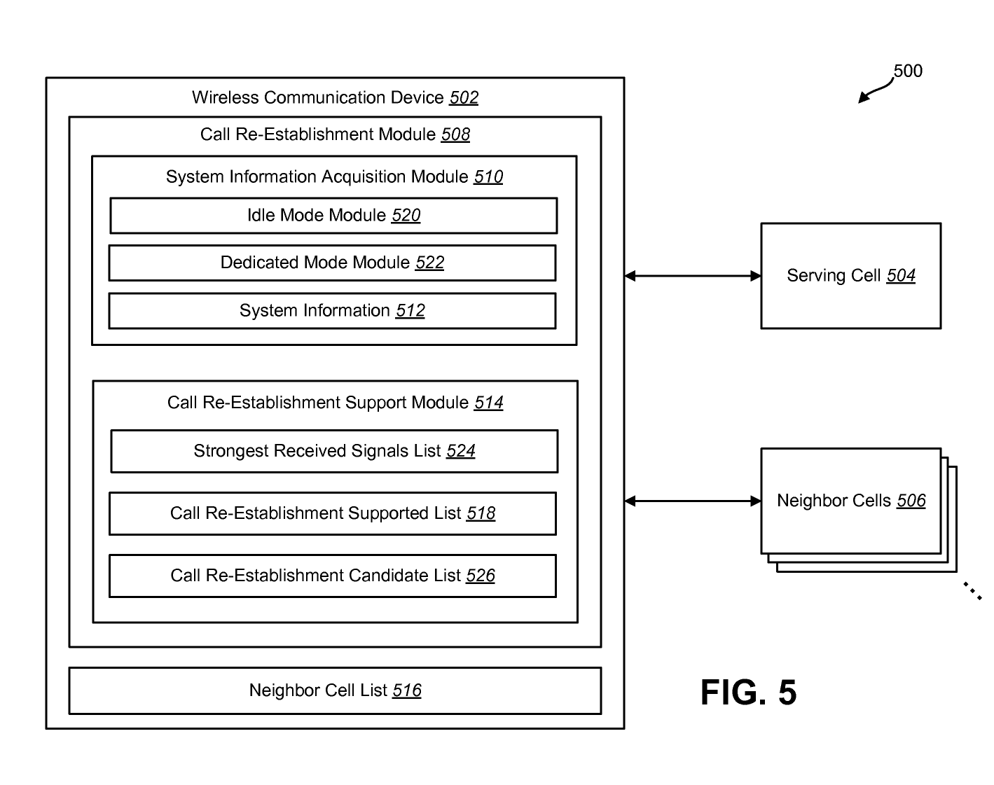

In one implementation, the wireless communication device 102 may attempt 410 call re-establishment starting with the neighbor cell 106 that has the strongest average received signal level (e.g., Rxlevel). If the call re-establishment is not successful, the wireless communication device 102 may attempt 410 call re-establishment on the neighbor cells 106 that have weaker average received signal levels. This may be accomplished as described below in connection with FIG. 5.

It should be noted that in the configuration described in connection with FIG. 4, the neighbor cells 106 may be added to the call re-establishment supported list 118 before a radio link failure occurs. Therefore, upon detecting a radio link failure, the wireless communication device 102 already has knowledge of which neighbor cells 106 support call re-establishment. By pre-determining which neighbor cells 106 support call re-establishment, the wireless communication device 102 may reduce that amount of time for performing a call re-establishment procedure in the event of a radio link failure.

FIG. 5 is a block diagram illustrating a configuration of a wireless communication system 500 for performing enhanced call re-establishment. The wireless communication system 500 may be a GSM system as described above in connection with FIG. 3. A wireless communication device 502 may be camped on a serving cell 504.

While camped on the serving cell 504, the wireless communication device 502 may receive a neighbor cell list 516 from the serving cell 504. In one configuration, the neighbor cell list 516 may be a BA list that is broadcast on a SACCH of the serving cell 504, as described above in connection with FIG. 1.

To improve call re-establishment, the wireless communication device 502 may perform enhanced call re-establishment. The wireless communication device 502 may include a system information acquisition module 510 and a call re-establishment support module 514.

The system information acquisition module 510 may obtain system information 512 from the neighbor cells 506 included in the neighbor cell list 516. The system information 512 may be a system information type 3 (SI3) message, a system information type 4 (SI4) message or any other system information containing a RACH control parameter IE.

An idle mode module 520 may obtain the system information 512 from the neighbor cells 506 while the wireless communication device 502 is in idle mode. The idle mode module 520 may obtain the system information 512 from one or more radio resource (RR) messages associated with the one or more neighbor cells 506.

A dedicated mode module 522 may obtain the system information 512 from the neighbor cells 506 while the wireless communication device 502 is in a dedicated mode. The dedicated mode module 522 may obtain the system information 512 of the one or more neighbor cells 506 using a tuneaway mechanism.

The call re-establishment support module 514 may determine whether the one or more neighbor cells 506 support call re-establishment based on the system information 512. The call re-establishment support module 514 may maintain a strongest received signals list 524. In one configuration, the strongest received signals list 524 may be a list of neighbor cells 506 with the strongest average received signal level that are considered for call re-establishment. As discussed above, the wireless communication device 502 may measure the received average signal level (e.g., Rxlevel) of the neighbor cells 506 in the neighbor cell list 516. The call re-establishment support module 514 may add a certain number N neighbor cells 506 with the strongest average received signals to the strongest received signals list 524.

In one implementation, N may be 6 neighbor cells 506. In this implementation, the wireless communication device 502 may add the 6 neighbor cells 506 with the strongest average received signals to the strongest received signals list 524.

Within the strongest received signals list 524, the neighbor cells 506 may be arranged from strongest to weakest average received signal. In other words, for the N neighbor cells 506 in the strongest received signals list 524, the neighbor cell 506 with the strongest average received signal may be first, the neighbor cell 506 with the second strongest average received signal may be second, and so forth.

The call re-establishment support module 514 may maintain a call re-establishment supported list 518 of neighbor cells 506 that support call re-establishment. The call re-establishment support module 514 may use information from the system information 512 to identify the neighbor cells 506 that support call re-establishment. If the system information 512 indicates that a neighbor cell 506 supports call re-establishment, then the call re-establishment support module 514 may add the neighbor cell 506 to the call re-establishment supported list 518. However, if the system information 512 indicates that a neighbor cell 506 does not support call re-establishment, then the call re-establishment support module 514 may omit (or remove) the neighbor cell 506 from the call re-establishment supported list 518.

The call re-establishment support module 514 may maintain a call re-establishment candidate list 526. In one configuration, the call re-establishment candidate list 526 may be the intersection of the strongest received signals list 524 and the call re-establishment supported list 518. In other words, the call re-establishment candidate list 526 may include only the neighbor cells 506 that appear on both the strongest received signals list 524 and the call re-establishment supported list 518.

In one implementation, the call re-establishment candidate list 526 may be arranged based on the strongest received signals list 524. Therefore, the neighbor cells 506 that are included in the call re-establishment candidate list 526 may be arranged from strongest to weakest average received signal.

The call re-establishment module 508 may attempt call re-establishment only on neighbor cells 506 in the call re-establishment candidate list 526. For example, upon detecting a radio link failure, the call re-establishment module 508 may attempt call re-establishment only on the neighbor cells 506 in the call re-establishment candidate list 526. The call re-establishment module 508 may attempt call re-establishment starting on the first neighbor cell 506 in the call re-establishment candidate list 526 and may proceed through the remaining neighbor cells 506 in the call re-establishment candidate list 526 if call re-establishment is unsuccessful.

In this way, the wireless communication device 502 may avoid wasting time attempting call re-establishment on neighbor cells 506 that do not support call re-establishment. Therefore, the wireless communication device 502 may reduce the amount of time for call re-establishment by maintaining a call re-establishment candidate list 526 that only includes the neighbor cells 506 with the strongest average received signals that also support call re-establishment.

In one example scenario, the wireless communication device 502 may receive a neighbor cell list 516 that includes the following neighbor cells 506: {Cell B, Cell C, Cell D, Cell E, Cell F, Cell G, Cell H, Cell I, Cell J, Cell K}. In this scenario, the six neighbor cells 506 (e.g., N=6) with the strongest average received signals are Cell B, Cell C, Cell D, Cell E, Cell F and Cell G, arranged from strongest to weakest average received signal. Furthermore, only Cell F, Cell G, Cell H and Cell I support call re-establishment.

In this scenario, the strongest received signals list 524 includes {Cell B, Cell C, Cell D, Cell E, Cell F, Cell G}. The call re-establishment supported list 518 includes {Cell F, Cell G, Cell H, Cell I}. The call re-establishment candidate list 526 is the intersection of the strongest received signals list 524 and call re-establishment supported list 518. Therefore, the call re-establishment candidate list 526 includes {Cell F, Cell G}. Upon detecting a radio link failure, the call re-establishment module 508 may then attempt call re-establishment using the call re-establishment candidate list 526. In this scenario, the call re-establishment module 508 may start with Cell F, thus reducing the amount of time that would have been wasted by attempting call re-establishment on neighbor cells 506 that do not support call re-establishment.

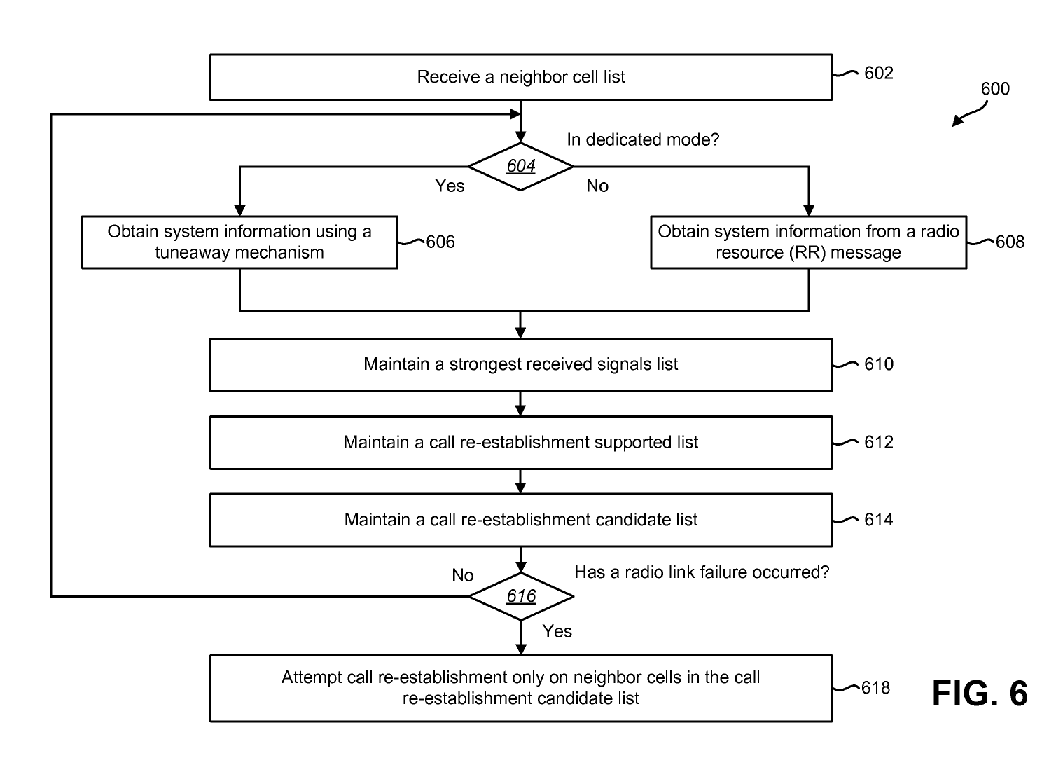

FIG. 6 is a flow diagram illustrating another detailed configuration of a method 600 for performing enhanced call re-establishment. The method 600 may be performed by a wireless communication device 502. The wireless communication device 502 may be camped on a serving cell 504. In one implementation, the wireless communication system 500 may be a GSM system.

While camped on the serving cell 504, the wireless communication device 502 may receive 602 a neighbor cell list 516 that includes one or more neighbor cells 506. In one configuration, the neighbor cell list 516 may be a BA list that is broadcast on a SACCH of the serving cell 504.

The wireless communication device 502 may determine 604 whether it is operating in a dedicated mode. For example, if the wireless communication device 502 is making a call (e.g., voice call or data call), then the wireless communication device 502 may be in a dedicated mode. If the wireless communication device 502 is in a dedicated mode, then the wireless communication device 502 may obtain 606 system information 512 from one or more tuneaway messages associated with the one or more neighbor cells 506. The system information 512 may be a system information type 3 (SI3) message, a system information type 4 (SI4) message or any other system information containing a RACH control parameter IE.

If the wireless communication device 502 determines 604 that it is not in dedicated mode (e.g., the wireless communication device 502 may be in an idle mode), then the wireless communication device 502 may obtain 608 the system information 512 from one or more radio resource (RR) messages associated with the one or more neighbor cells 506.

The wireless communication device 502 may maintain 610 a strongest received signals list 524. In one configuration, the strongest received signals list 524 may be a list of neighbor cells 506 with the strongest average received signal levels that are considered for call re-establishment. The wireless communication device 502 may add a certain number N neighbor cells 506 with the strongest average received signals to the strongest received signals list 524.

The wireless communication device 502 may maintain 612 a call re-establishment supported list 518. In one configuration, the call re-establishment supported list 518 may be a list of neighbor cells 506 that support call re-establishment. The wireless communication device 502 may use information from the system information 512 to identify the neighbor cells 506 that support call re-establishment. If the system information 512 indicates that a neighbor cell 506 supports call re-establishment, then the wireless communication device 502 may add the neighbor cell 506 to the call re-establishment supported list 518. However, if the system information 512 indicates that a neighbor cell 506 does not support call re-establishment, then the wireless communication device 502 may omit (or remove) the neighbor cell 506 from the call re-establishment supported list 518.

The wireless communication device 502 may maintain 614 a call re-establishment candidate list 526. In one configuration, the call re-establishment candidate list 526 may be the intersection of the strongest received signals list 524 and the call re-establishment supported list 518. In other words, the call re-establishment candidate list 526 may include only the neighbor cells 506 that appear on both the strongest received signals list 524 and the call re-establishment supported list 518.

The wireless communication device 502 may determine 616 whether a radio link failure has occurred. This may be accomplished as described above in connection with FIG. 1. If a radio link failure has not occurred, then the wireless communication device 502 may continue updating the system information 512 of the neighbor cells 506 and may continue maintaining the strongest received signals list 524, the call re-establishment supported list 518 and the call re-establishment candidate list 526.

If the wireless communication device 502 determines 616 that a radio link failure has occurred, then the wireless communication device 502 may attempt 618 call re-establishment only on neighbor cells 506 in the call re-establishment candidate list 526. The wireless communication device 502 may attempt 618 call re-establishment starting on the first neighbor cell 506 in the call re-establishment candidate list 526 and may proceed through the remaining neighbor cells 506 in the call re-establishment candidate list 526 if call re-establishment is unsuccessful.

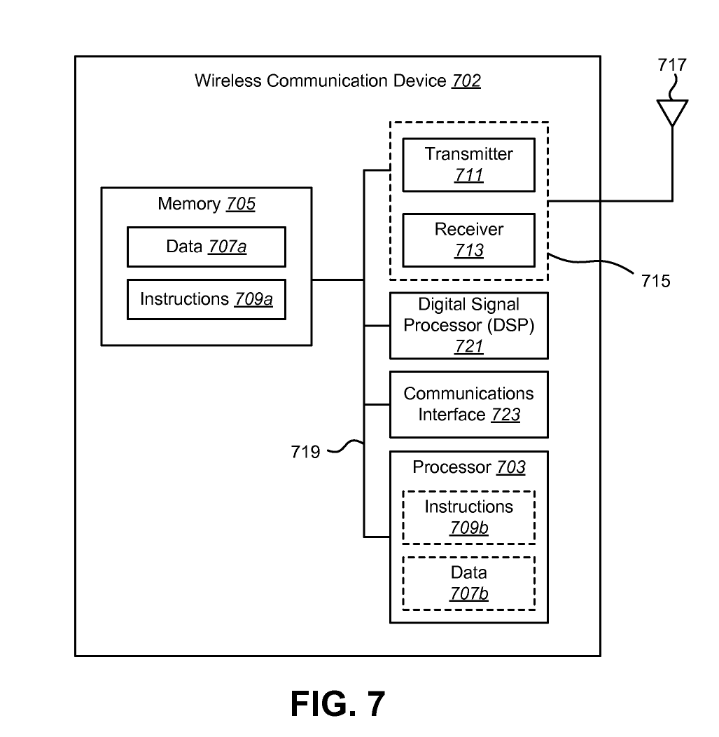

FIG. 7 illustrates certain components that may be included within a wireless communication device 702. The wireless communication device 702 may be an access terminal, a mobile station, a user equipment (UE), etc. For example, the wireless communication device 702 may be the wireless communication device 102 of FIG. 1.

The wireless communication device 702 includes a processor 703. The processor 703 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 703 may be referred to as a central processing unit (CPU). Although just a single processor 703 is shown in the wireless communication device 702 of FIG. 7, in an alternative configuration, a combination of processors (e.g., an ARM and DSP) could be used.

The wireless communication device 702 also includes memory 705. The memory 705 may be any electronic component capable of storing electronic information. The memory 705 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 707a and instructions 709a may be stored in the memory 705. The instructions 709a may be executable by the processor 703 to implement the methods disclosed herein. Executing the instructions 709a may involve the use of the data 707a that is stored in the memory 705. When the processor 703 executes the instructions 709, various portions of the instructions 709b may be loaded onto the processor 703, and various pieces of data 707b may be loaded onto the processor 703.

The wireless communication device 702 may also include a transmitter 711 and a receiver 713 to allow transmission and reception of signals to and from the wireless communication device 702 via an antenna 717. The transmitter 711 and receiver 713 may be collectively referred to as a transceiver 715. The wireless communication device 702 may also include (not shown) multiple transmitters, multiple antennas, multiple receivers and/or multiple transceivers.

The wireless communication device 702 may include a digital signal processor (DSP) 721. The wireless communication device 702 may also include a communications interface 723. The communications interface 723 may allow a user to interact with the wireless communication device 702.

The various components of the wireless communication device 702 may be coupled together by one or more buses, which may include a power bus, a control signal bus, a status signal bus, a data bus, etc. For the sake of clarity, the various buses are illustrated in FIG. 7 as a bus system 719.

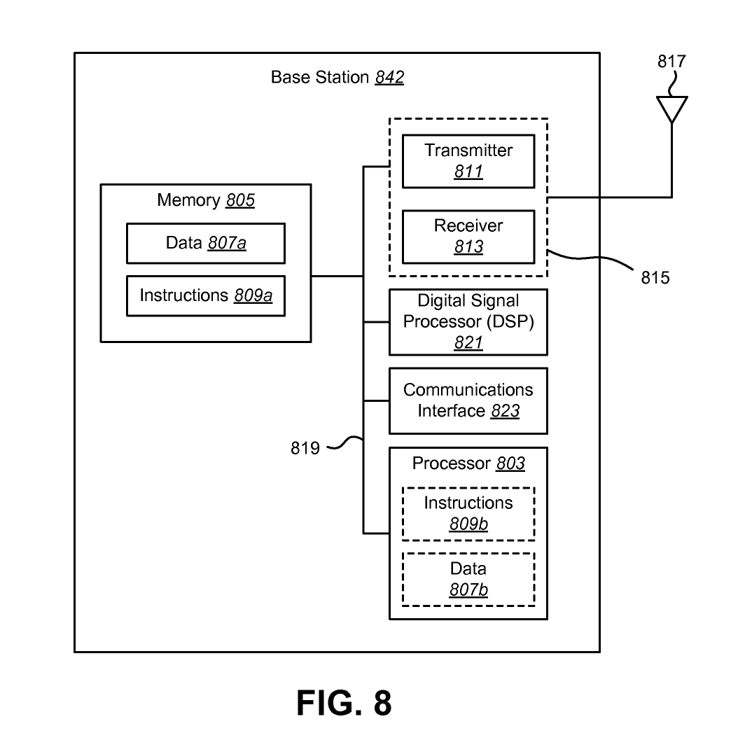

FIG. 8 illustrates certain components that may be included within a base station 842. A base station 842 may also be referred to as, and may include some or all of the functionality of, an access point, a broadcast transmitter, a NodeB, an evolved NodeB, etc. For example, the base station 842 may be the base station 342 of FIG. 3.

The base station 842 may include a processor 803. The processor 803 may be a general purpose single- or multi-chip microprocessor (e.g., an ARM), a special purpose microprocessor (e.g., a digital signal processor (DSP)), a microcontroller, a programmable gate array, etc. The processor 803 may be referred to as a central processing unit (CPU). Although just a single processor 803 is shown in the base station 842 of FIG. 8, in an alternative configuration, a combination of processors (e.g., an ARM and DSP) could be used.

The base station 842 also includes memory 805. The memory 805 may be any electronic component capable of storing electronic information. The memory 805 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions 809a may be executable by the processor 803 to implement the methods disclosed herein. Executing the instructions 809a may involve the use of the data 807a that is stored in the memory 805. When the processor 803 executes the instructions 809a, various portions of the instructions 809b may be loaded onto the processor 803, and various pieces of data 807b may be loaded onto the processor 803.

The base station 842 may also include a transmitter 811 and a receiver 813 to allow transmission and reception of signals to and from the base station 842. The transmitter 811 and receiver 813 may be collectively referred to as a transceiver 815. An antenna 817 may be electrically coupled to the transceiver 815. The base station 842 may also include (not shown) multiple transmitters, multiple receivers, multiple transceivers and/or additional antennas.

The base station 842 may include a digital signal processor (DSP) 821. The base station 842 may also include a communications interface 823. The communications interface 823 may allow a user to interact with the base station 842.

The various components of the base station 842 may be coupled together by one or more buses, which may include a power bus, a control signal bus, a status signal bus, a data bus, etc. For the sake of clarity, the various buses are illustrated in FIG. 8 as a bus system 819.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The functions described herein may be implemented in software or firmware being executed by hardware. The functions may be stored as one or more instructions on a computer-readable medium. The terms “computer-readable medium” or “computer-program product” refer to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, FIG. 4 and FIG. 6 can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods and apparatus described herein without departing from the scope of the claims.

What is claimed is:

1. A method for call re-establishment by a wireless communication device, comprising:
obtaining system information from one or more neighbor cells in a wireless communication system;
determining whether the one or more neighbor cells support call re-establishment based on the system information; and
attempting call re-establishment only on neighbor cells that support call re-establishment.

2. The method of claim 1, wherein attempting call re-establishment occurs when a radio link failure is detected.

3. The method of claim 1, wherein the wireless communication system is a Global System for Mobile Communications (GSM) system.

4. The method of claim 1, wherein attempting call re-establishment only on neighbor cells that support call re-establishment comprises skipping neighbor cells that do not support call re-establishment.

5. The method of claim 1, further comprising maintaining a call re-establishment supported list of neighbor cells that support call re-establishment.

6. The method of claim 5, further comprising:
identifying neighbor cells that support call re-establishment using information from the system information;
adding the neighbor cells that support call re-establishment to the call re-establishment supported list; and
attempting call re-establishment on neighbor cells based on the call re-establishment supported list.

7. The method of claim 1, further comprising obtaining, from a neighbor cell, the system information from a radio resource (RR) message when in idle mode or by decoding neighbor cell system information using a tuneaway mechanism when in dedicated mode, wherein the system information is at least one of a system information type 3 (SI3) message or a system information type 4 (SI4) message or other system information containing a random access channel (RACH) control parameter information element (IE).

8. The method of claim 1, further comprising:
receiving, while camped on a serving cell, a neighbor cell list that includes the one or more neighbor cells;
maintaining a strongest received signals list of neighbor cells with strongest average received signal levels that are considered for call re-establishment;
maintaining a call re-establishment supported list of neighbor cells that support call re-establishment; and
maintaining a call re-establishment candidate list that is an intersection of the strongest received signals list and the call re-establishment supported list, wherein attempting call re-establishment only on neighbor cells that support call re-establishment comprises attempting call re-establishment only on neighbor cells in the call re-establishment candidate list.

9. An apparatus for call re-establishment, comprising:
a processor;
memory in electronic communication with the processor; and
instructions stored in the memory, the instructions being executable by the processor to:
obtain system information from one or more neighbor cells in a wireless communication system;
determine whether the one or more neighbor cells support call re-establishment based on the system information; and
attempt call re-establishment only on neighbor cells that support call re-establishment.

10. The apparatus of claim 9, wherein attempting call re-establishment occurs when a radio link failure is detected.

11. The apparatus of claim 9, wherein the wireless communication system is a Global System for Mobile Communications (GSM) system.

12. The apparatus of claim 9, wherein the instructions executable to attempt call re-establishment only on neighbor cells that support call re-establishment comprise instructions executable to skip neighbor cells that do not support call re-establishment.

13. The apparatus of claim 9, further comprising instructions executable to maintain a call re-establishment supported list of neighbor cells that support call re-establishment.

14. The apparatus of claim 13, further comprising instructions executable to:
identify neighbor cells that support call re-establishment using information from the system information;
add the neighbor cells that support call re-establishment to the call re-establishment supported list; and
attempt call re-establishment on neighbor cells based on the call re-establishment supported list.

15. The apparatus of claim 9, further comprising instructions executable to obtain, from a neighbor cell, the system information from a radio resource (RR) message when in idle mode or by decoding neighbor cell system information using a tuneaway mechanism when in dedicated mode, wherein the system information is at least one of a system information type 3 (SI3) message or a system information type 4 (SI4) message or other system information containing a random access channel (RACH) control parameter information element (IE).

16. The apparatus of claim 9, further comprising instructions executable to:
receive, while camped on a serving cell, a neighbor cell list that includes the one or more neighbor cells;
maintain a strongest received signals list of neighbor cells with strongest average received signal levels that are considered for call re-establishment;
maintain a call re-establishment supported list of neighbor cells that support call re-establishment; and
maintain a call re-establishment candidate list that is an intersection of the strongest received signals list and the call re-establishment supported list, wherein the instructions executable to attempt call re-establishment only on neighbor cells that support call re-establishment comprise instructions executable to attempt call re-establishment only on neighbor cells in the call re-establishment candidate list.

17. A wireless communication device for call re-establishment, comprising:
means for obtaining system information from one or more neighbor cells in a wireless communication system;
means for determining whether the one or more neighbor cells support call re-establishment based on the system information; and
means for attempting call re-establishment only on neighbor cells that support call re-establishment.

18. The wireless communication device of claim 17, wherein the wireless communication system is a Global System for Mobile Communications (GSM) system.

19. The wireless communication device of claim 17, wherein the means for attempting call re-establishment only on neighbor cells that support call re-establishment comprise means for skipping neighbor cells that do not support call re-establishment.

20. The wireless communication device of claim 17, further comprising means for maintaining a call re-establishment supported list of neighbor cells that support call re-establishment.

21. The wireless communication device of claim 20, further comprising:
means for identifying neighbor cells that support call re-establishment using information from the system information;
means for adding the neighbor cells that support call re-establishment to the call re-establishment supported list; and
means for attempting call re-establishment on neighbor cells based on the call re-establishment supported list.

22. The wireless communication device of claim 17, further comprising means for obtaining, from a neighbor cell, the system information from a radio resource (RR) message when in idle mode or by decoding neighbor cell system information using a tuneaway mechanism when in dedicated mode, wherein the system information is at least one of a system information type 3 (SI3) message or a system information type 4 (SI4) message or other system information containing a random access channel (RACH) control parameter information element (IE).

23. The wireless communication device of claim 17, further comprising:
means for receiving, while camped on a serving cell, a neighbor cell list that includes the one or more neighbor cells;
means for maintaining a strongest received signals list of neighbor cells with strongest average received signal levels that are considered for call re-establishment;
means for maintaining a call re-establishment supported list of neighbor cells that support call re-establishment; and
means for maintaining a call re-establishment candidate list that is an intersection of the strongest received signals list and the call re-establishment supported list, wherein the means for attempting call re-establishment only on neighbor cells that support call re-establishment comprise means for attempting call re-establishment only on neighbor cells in the call re-establishment candidate list.

24. A computer-program product for call re-establishment, the computer-program product comprising a non-transitory computer-readable medium having instructions thereon, the instructions comprising:
code for causing a wireless communication device to obtain system information from one or more neighbor cells in a wireless communication system;
code for causing the wireless communication device to determine whether the one or more neighbor cells support call re-establishment based on the system information; and
code for causing the wireless communication device to attempt call re-establishment only on neighbor cells that support call re-establishment.

25. The computer-program product of claim 24, wherein the wireless communication system is a Global System for Mobile Communications (GSM) system.

26. The computer-program product of claim 24, wherein the code for causing the wireless communication device to attempt call re-establishment only on neighbor cells that support call re-establishment comprises code for causing the wireless communication device to skip neighbor cells that do not support call re-establishment.

27. The computer-program product of claim 24, further comprising code for causing the wireless communication device to maintain a call re-establishment supported list of neighbor cells that support call re-establishment.

28. The computer-program product of claim 27, further comprising:
code for causing the wireless communication device to identify neighbor cells that support call re-establishment using information from the system information;
code for causing the wireless communication device to add the neighbor cells that support call re-establishment to the call re-establishment supported list; and
code for causing the wireless communication device to attempt call re-establishment on neighbor cells based on the call re-establishment supported list.

29. The computer-program product of claim 24, further comprising code for causing the wireless communication device to obtain, from a neighbor cell, the system information from a radio resource (RR) message when in idle mode or by decoding neighbor cell system information using a tuneaway mechanism when in dedicated mode, wherein the system information is at least one of a system information type 3 (SI3) message or a system information type 4 (SI4) message or other system information containing a random access channel (RACH) control parameter information element (IE).

30. The computer-program product of claim 24, further comprising:
code for causing the wireless communication device to receive, while camped on a serving cell, a neighbor cell list that includes the one or more neighbor cells;
code for causing the wireless communication device to maintain a strongest received signals list of neighbor cells with strongest average received signal levels that are considered for call re-establishment;
code for causing the wireless communication device to maintain a call re-establishment supported list of neighbor cells that support call re-establishment; and
code for causing the wireless communication device to maintain a call re-establishment candidate list that is an intersection of the strongest received signals list and the call re-establishment supported list, wherein the code for causing the wireless communication device to attempt call re-establishment only on neighbor cells that support call re-establishment comprises code for causing the wireless communication device to attempt call re-establishment only on neighbor cells in the call re-establishment candidate list.
